(19) United States
(12) Patent Application Publication
(10) Pub. No.: US 2018/0186463 A1
(43) Pub. Date: Jul. 5, 2018

(54) PRIMARY STRUCTURE OF A PYLON FOR AN AIRCRAFT ENGINE ASSEMBLY COMPRISING A PYRAMIDAL PART WITH CONVERGING UPRIGHT MEMBERS

(71) Applicant: Airbus Operations (S.A.S.), Toulouse (FR)

(72) Inventors: Guillaume Gallant, Plaisance Du Touch (FR); Olivier Gleize, Toulouse (FR)

(21) Appl. No.: 15/854,912

(22) Filed: Dec. 27, 2017

(30) Foreign Application Priority Data
Dec. 27, 2016 (FR) 1663434

(51) Int. Cl. B64D 27/26

(52) U.S. Cl. CPC B64D 27/26; B64D 2027/268; B64D 2027/264

(57) ABSTRACT

A primary structure of a support pylon for an aircraft engine assembly. The primary structure includes a pyramidal part, the pyramidal part including a single rib, the single rib forming the base of the pyramidal part, and straight, upright members converging towards an apex point of the pyramidal part, a fastening interface being provided at the apex of the pyramidal part. A pyramidal part based on upright members converging towards the apex of the pyramid enables loads in the upright members to be distributed, via a simple structure. This structure furthermore enables the integration of components within the pyramidal part.

### CROSS REFERENCE TO RELATED APPLICATIONS

This application claims priority to French Patent Application FR 1663434, filed Dec. 27, 2016, the entire disclosure of which is incorporated by reference herein.

### TECHNICAL FIELD

The present disclosure relates to support pylons for an aircraft engine assembly.

### BACKGROUND

In an aircraft, a pylon is an element that forms the link between an engine assembly and the structure of the aircraft, for example around the wing system or fuselage thereof.

The pylon includes a primary structure that can absorb and transmit the loads applied to the pylon, and a secondary structure essentially forming an aerodynamic fairing with no structural role. The fairing or secondary structure is used to receive cables and pipes linking an engine assembly to the rest of the aircraft.

The primary structure comprises a general box structure, in a known manner. In particular, the primary structure has a given number of substantially parallel ribs. To form the primary structure, longerons (upper and lower) and lateral plates are fastened to the ribs to form a box structure. Such a box structure of the primary structure provides the pylon with high stiffness and high strength, which are required to transmit loads between the engine assembly and the structure of the aircraft, while ensuring low mass.

The primary structure of the pylon also has attachments designed to link the pylon firstly to the structure of the aircraft and secondly to the engine assembly.

The primary structure of an aircraft pylon can have a complex shape comprising two boxed pyramid frustrums, as shown in FIG. 1 attached.

This conventional structure is nonetheless complex and provides limited options for building additional functions into the primary structure, on account of the subdivision thereof by ribs.

Document EP1928741 discloses a primary pylon structure for an aircraft engine assembly in which the architecture is simplified by the use of a monolithic frame. The industrial production of such a primary structure is however complex. Furthermore, this structure can be further improved to provide options for optimizing the architecture of the aircraft.

The subject matter herein thus discloses an alternative structure that is simple and that provides options for architectural optimization of a primary structure of a support pylon of an aircraft engine assembly.

### SUMMARY

Thus, the subject matter herein concerns a primary structure of a support pylon of an aircraft engine assembly, including fastening interfaces with the aircraft engine assembly on one hand and with the structure of the aircraft on the other hand. The primary structure comprises a pyramidal part, the pyramidal part comprising a single rib, the single rib forming the base of the pyramidal part, and straight, upright members converging towards an apex point of the pyramidal part, a fastening interface being provided at the apex of the pyramidal part.

A pyramidal part based on upright members converging towards the apex of the pyramid, where a connection interface is provided, enables loads in the upright members to be distributed, via a simple structure. The aforementioned geometric layout ensures that the loads in the upright members are essentially traction and compression loads, which enables large loads to be absorbed using a lightweight structure.

The pyramidal part can be open on at least two faces.

The pyramidal part can for example comprise four upright members.

In one embodiment, the upright members of the pyramidal part are tubular.

The tubular upright members can for example have a circular, square, rectangular or triangular section.

The upright members can notably be made of titanium or of titanium alloy.

In another embodiment, the upright members have a profile reinforced by a cell structure. The upright members can have a C-section profile, the cell structure being arranged inside the “C” formed by the profile.

Two upright members can include a fin forming a flat extension of the section of same, the fin being designed to fasten a shear web between the two upright members. The shear web can for example be made of a composite material or of titanium.

The interface at the apex of the pyramidal part can be a fastening interface with the aircraft. The interface enables the link with the structure of the aircraft. The fastening interface can for example form a hole for a bearing or roller bearing. In this case, the hole can have a main shaft, the convergence apex of the straight upright members of the pyramidal part being located on the main shaft of the hole.

In particular, the fastening interface is a yoke designed to receive a shaft, the straight upright members of the pyramidal part converging on the shaft.

The primary structure can include, at one end of each upright member opposite the apex of the pyramidal part, a connection part that is linked to the upright member and that determines the orientation of the upright member in relation to the rest of the primary structure, and that is designed to be rigidly linked to the rest of the primary structure.

The primary structure of a support pylon for an aircraft engine assembly can include, in addition to the pyramidal part, a boxed structure to which the base of the pyramidal part is linked.

The disclosure herein also relates to a support pylon for an aircraft engine assembly including a primary structure as described above.

Other details and advantages of the disclosure herein are set out in the description below.

### BRIEF DESCRIPTION OF THE DRAWINGS

FIG. 1 is a three-dimensional schematic view of a primary structure of a pylon of an aircraft engine assembly according to the prior art;

FIG. 2 is a schematic profile view of a primary structure of a pylon according to one embodiment of the disclosure herein;

FIG. 3 is a partial schematic three-dimensional view of a pyramidal part implemented in the primary structure of a pylon of an aircraft engine assembly in FIG. 2;

FIG. 4 is a first schematic partial cross-section view of a primary structure of a pylon of an aircraft engine assembly according to one embodiment of the disclosure herein;

FIG. 5 is a second partial schematic cross-section view of the primary structure of a pylon of an aircraft engine assembly in FIG. 4;

FIG. 6 is a first example section of an upright member that can be implemented according to the disclosure herein;

FIG. 7 is a second example section of an upright member that can be implemented according to the disclosure herein;

FIG. 8 is a third example section of an upright member that can be implemented according to the disclosure herein;

FIG. 9 is a partial schematic cross-section view similar to the view in FIG. 4 of the primary structure of a pylon of an engine assembly implementing the upright members with the section shown in FIG. 8;

FIG. 10 is a second partial schematic cross-section view of the primary structure of a pylon of an aircraft engine assembly in FIG. 9; and

FIG. 11 is a third partial schematic cross-section view of the primary structure of a pylon of an aircraft engine assembly in FIG. 9.

### DETAILED DESCRIPTION

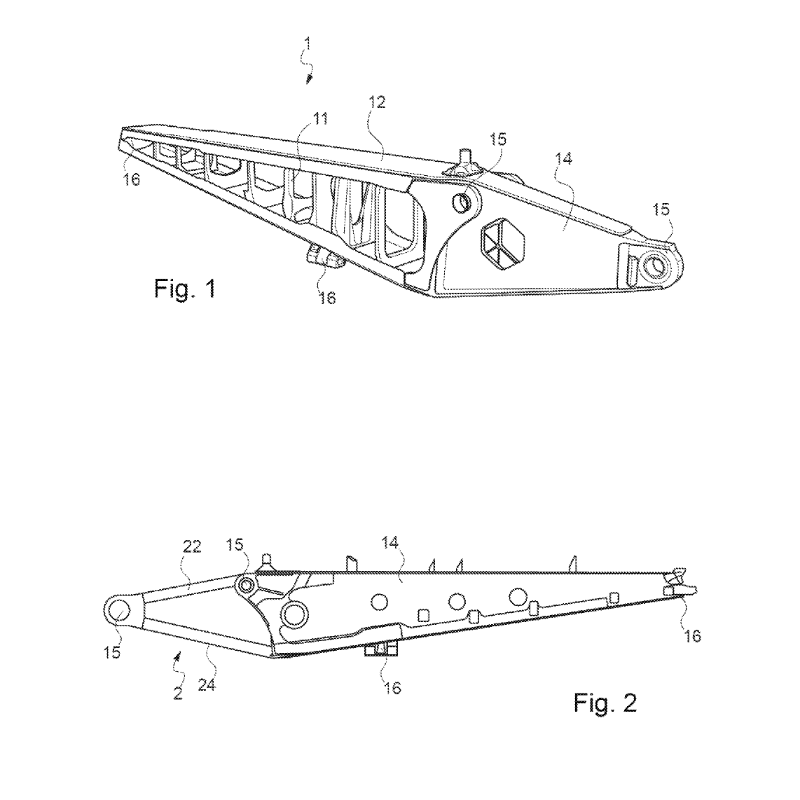

FIG. 1 shows a primary structure of a pylon of an aircraft engine assembly as known in the prior art.

In an aircraft, a pylon is an element that forms the link between an engine assembly, comprising an engine and a nacelle, and a structure of the aircraft, usually around the wing system or fuselage thereof.

The pylon includes a primary structure that can absorb and transmit the loads applied to the pylon, and a secondary structure essentially forming an aerodynamic fairing with no structural role.

The primary structure 1 includes a given number of substantially parallel ribs 11. To form the primary structure, an upper longeron 12, a lower longeron 13 and lateral plates 14 are fastened to the ribs 11 to form a box structure. In FIG. 1, certain lateral plates 14 of the sides of the longeron are not shown to reveal the internal structure of the primary structure 1. Such a box structure provides the primary structure, and therefore the pylon, with high stiffness and high strength, which are required to transmit loads between the engine assembly and the structure of the aircraft.

The primary structure of the pylon also has attachments designed to link the pylon firstly to the structure of the aircraft and secondly to the engine assembly. More specifically, the primary structure has fastening interfaces 15 with the aircraft, and fastening interfaces 16 with the engine assembly. In order to reduce the number of ribs used, notably in the portion of the primary structure between the fastening interfaces 15 with the aircraft, cellular lateral plates 14 may be used, for example ISOGRID® plates.

An ISOGRID® cell structure is a structure comprising a plate that is reinforced on one face by ribs forming cells or cavities with the surface of the plate. An ISOGRID® cell structure is a structure in which the ribs form a regular pattern of triangles with the surface of the plate. Such a structure is extremely stiff with limited mass.

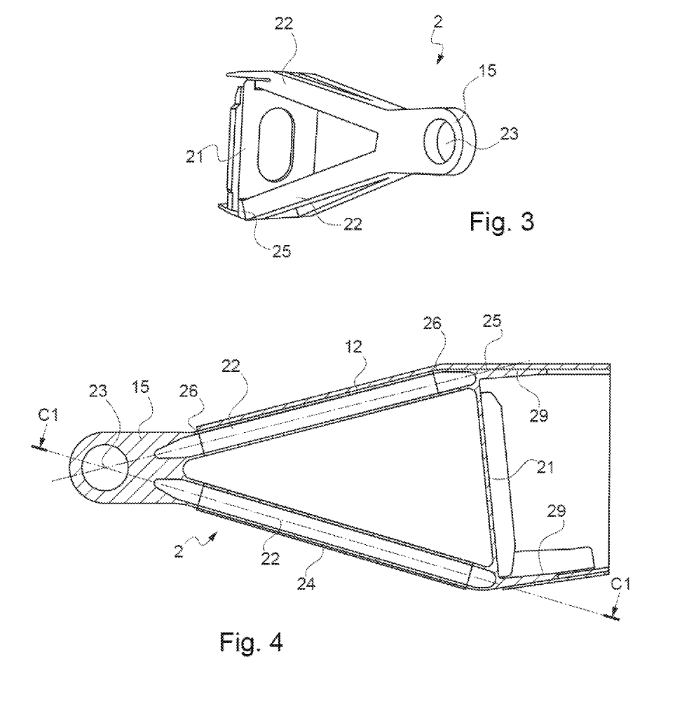

FIG. 2 shows a primary structure of a pylon for an aircraft engine assembly according to one embodiment of the disclosure herein. The primary structure 1 in FIG. 2 differs essentially from the prior art in that it has a specific pyramidal part 2 that is shown in greater detail in FIG. 3. This pyramidal part 2 has no ribs, except for a single rib 21 forming the base of the pyramid. The single rib can be made of a titanium plate, potentially apertured. Furthermore, the pyramidal part 2 is delimited by upright members 22, of which there are four in the example embodiment shown here. The upright members 22 form the edges of the pyramidal part 2. The upright members 22 are straight, and each one extends in a respective extension direction. The upright members 22, or more specifically the extension directions of the upright members, converge towards a point that is the apex 23 of the pyramid formed by the pyramidal part 2.

A fastening interface, in this case a fastening interface 15 with the aircraft, is provided at the apex of the pyramidal part 2. The fastening interface is in this case a hole for inserting a bearing and/or a fastening roller bearing. The hole is centered on the apex 23 of the pyramid. More specifically, the fastening interface shown here is in the form of a yoke, i.e. a U-shaped part that is designed to receive a shaft in order to form a pivoting link with an element inserted between the branches of the U.

The upright members 22 advantageously converge on the shaft of the yoke, or the center of the hole designed to receive a bearing or roller bearing.

This convergence makes it possible to eliminate any shear load in the upright members 22 of the pyramidal part 2 by cancelling out the shear load in each arm. Each upright member 22 is therefore only subject to a pure traction-compression load.

The presence of a web linking the upper and lower arms of the pyramid is no longer required. This reduces the quantity of material required to make the primary structure and improves access to the systems contained in the primary structure. Furthermore, the moments exerted locally in the vicinity of the link (for example of the yoke) are cancelled out.

On the pyramidal part 2, a shear web 24 links two upright members 22 and enables absorption of the shear loads applied to the pyramidal part 2. The shear web 24 can be formed by a rigid plate linking the two upright members 22 in the lower portion of the pyramidal part 2.

As shown in FIGS. 2 and 3, this pyramidal part 2 has a simple layout. Furthermore, the pyramidal part 2 frees up an internal volume that can be used for a range of functions (such as storing automatic extinguisher cartridges). This is also facilitated by the fact that the pyramidal part 2 can be left open, as shown in FIGS. 2 and 3, on at least two of the faces thereof.

At one end of each upright member opposite the apex of the pyramidal part, a connection part 25 that is linked to the upright member and that determines the orientation of the upright member in relation to the rest of the primary structure is designed to be rigidly linked to the rest of the primary structure.

The pyramidal part 2 implemented can be made according to numerous variants and embodiments. Notably, the section and composition of the upright members 22 can vary depending on the embodiment.

FIG. 4 is a partial view of a primary support structure of an aircraft engine assembly according to one embodiment of the disclosure herein, including a pyramidal part 2 that is essentially identical to the one in FIG. 3, but in which the upright members 22 are round tubes, i.e. of circular section.

FIG. 4 is a cross sectional side view, the cutting plane being determined by the main axes of extension of two of the upright members 22. In other words, the cutting plane passes through two of the upright members 22 diametrically.

The upright members 22 are hollow and linked, for example by welding, to the connection part 25 at the end thereof opposite the apex of the pyramid. At the opposite end, on the side of the apex of the pyramid, the upright members are linked to the fastening interface 15 with the aircraft.

In the example shown here, both the connection part 25 and the fastening interface 15 with the aircraft are formed to enable a link to an upright member having a straight end, in a plane perpendicular to the overall extension direction thereof. Thus, the shape of the connection part 25, notably at the connection interfaces 26, determines the extension direction of the upright members 22 towards the apex 23. The connection interface 26 is one end of the connection part 25 that is designed to be linked to an upright member 22. The shape thereof therefore matches the end of the upright member 22, for example to enable welding thereof. The shape of the connection interface 26 can match the end of the upright members 22 linked thereto, whether same has a straight end, beveled end or other. Such a shape of the part 25 is applicable to all embodiments of the disclosure herein, notably regardless of the section of the upright members 22.

Similarly, the fastening interface 15 with the aircraft can be provided with connection interfaces 26 with the upright members 22 in which the orientation is adapted and the shape matches the end of the upright member 22 linked thereto, to enable the connection thereof, for example by welding.

In all embodiments, the connection part 25 can also have tabs 29 to make an easy link between the pyramidal part 2 and the rest of the primary structure 1.

The connection part 25, like all fastening interfaces 15 with the aircraft, can be obtained using different manufacturing methods, notably by molding, notably in a foundry, by three-dimensional printing, or by machining of a forged blank. The connection part, and/or where applicable the fastening interface 15 with the aircraft, can be made in several parts and assembled by welding. In general, the pyramidal part 2 can be made of parts assembled by welding.

The upright members 22 can be obtained using different manufacturing methods, for example by extrusion.

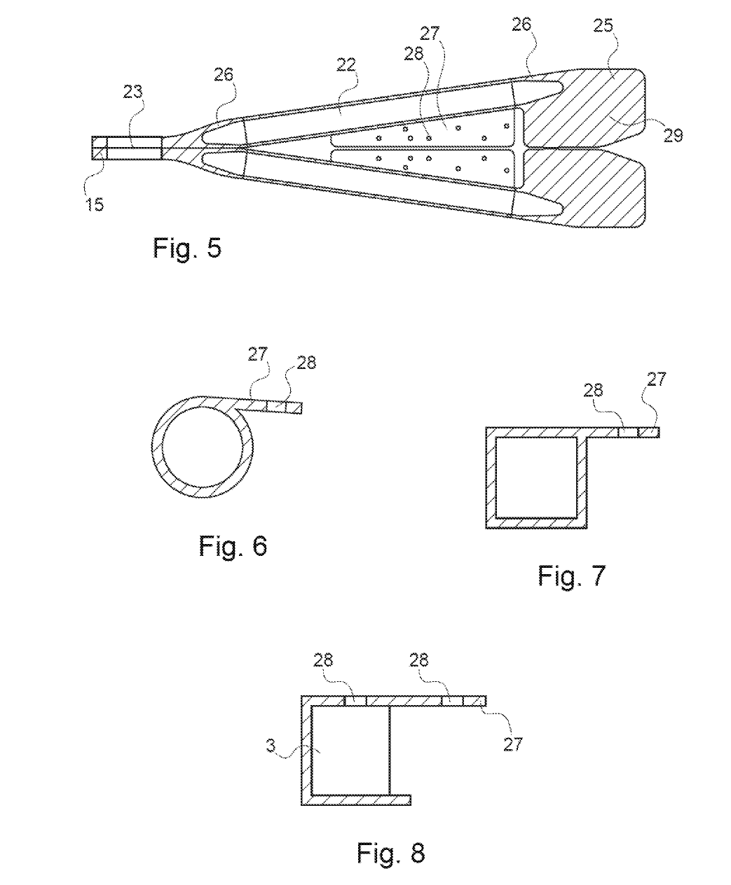

FIG. 5 is a partial cross section along the cutting plane C1C1 shown in FIG. 4. Thus, the fastening interfaces 15 with the aircraft and the connection part 25 are shown in cross section. The upright members 22 are shown in cross section and notably have fins 27. The fins 27 reinforce the upright members 22. The fins 27 also enable a shear web 24 to be fastened to the pyramidal part. For this purpose, the fins 27 are provided with orifices 28 for riveting or screw fastening of the shear web 24.

FIG. 6 shows the section of an upright member 22 according to a first example.

The section is circular and, being a tube, hollow. The fin 27 forms a flat extension of the section of the upright member 22.

FIG. 7 shows, as a cross section similar to the one in FIG. 5, the section of an upright member 22 according to a second example.

The section is square and, being a tube, hollow. The fin 27 forms a flat extension of the section of the upright member 22.

In the example sections shown in FIGS. 6 and 7, the fin 27 can be attached by welding to the section of the upright member 22. The fin 27 can be provided on only some of the length of the upright member 22. The width of the fin 27 varies along the upright member 22 such as to maintain a constant gap between the fins 27 of two facing upright members 22. The gap between the fins 27 of two facing upright members is preferably small, to maximize the surface of the fins 27.

FIG. 8 shows, as a cross section similar to the one in FIG. 5, the section of an upright member 22 according to a third example. In this example, the upright member is an open profile. In this case, the profile is C-shaped. The profile is reinforced by inserting a cell structure 3 into the space formed by the “C”. Preferably, the cell structure 3 is ISOGRID (registered trademark).

The fin 27 can be formed directly by the section of the profile.

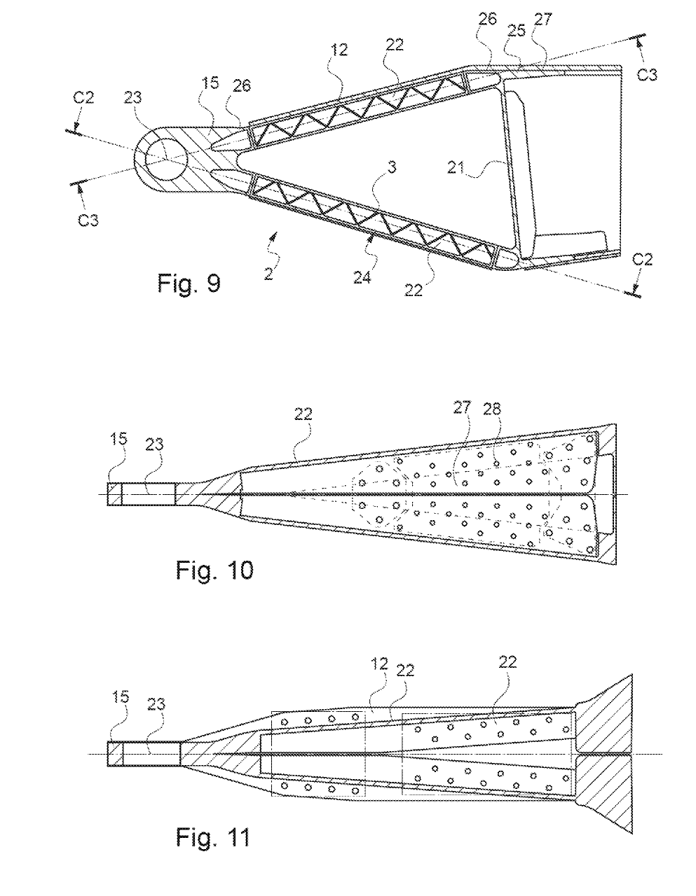

FIG. 9 is a partial view similar to the view in FIG. 4 of the primary structure of a pylon of an engine assembly implementing the upright members with the section shown in FIG. 8. FIG. 10 shows the primary structure in FIG. 9 as a cross section similar to the one in FIG. 5, i.e. along the cutting plane C2-C2 shown in FIG. 9.

This embodiment is essentially identical to the one in FIGS. 4 and 5, but has upright members 22 reinforced by an ISOGRID® cell structure 3, shown in the cross section in FIG. 8. The connection interfaces 26 are adapted to the shape and layout of the upright members 22. The fin 27 of an upright member 22 can extend along the entire length of the upright member 22. The fin 27 can notably be formed directly and integrally with the upright member 22. The connection interface 26, at the fastening interface 15 with the aircraft and/or the connection interface 26 at the connection part 25 can be formed to enable the fastening of the fin 27, notably by welding.

The width of the fin 27 varies along the upright member 22 such as to maintain a constant gap between the fins 27 of the two facing upright members 22. The gap between the fins 27 of two facing upright members is preferably small, to maximize the surface of the fins 27. A surface is thus formed, enabling the fastening of a shear web, for example by screwing or riveting via the orifices 28.

FIG. 11 shows the primary structure in FIG. 9 as a cross section taken in the cutting plane C3-C3 shown in FIG. 9. The upright members 22 move together and converge towards the apex 23, and have a tapered shape close to the apex 23. This change in the section of the upright members prevents the mechanical interference of same close to the apex 23. An upper longeron 12 is fastened to the upright members 22.

The disclosure herein thus developed, in which a primary structure of a pylon of an aircraft engine assembly has a pyramidal part based on upright members converging towards the apex of the pyramid, where a fastening interface is provided, enables the loads on the upright members to be distributed using a simple structure. According to different layouts of the disclosure herein, the structure can provide an internal volume, which can be open and which can be used to house functions usually installed in the fairing of the pylon, outside the primary structure. This for example enables the volume of the fairing and the aerodynamic drag thereof to be limited. In general, the disclosure herein enables the primary structure of a pylon of an aircraft engine assembly to be simplified and lightened.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A primary structure of a support pylon of an aircraft engine assembly, including fastening interfaces with the aircraft engine assembly and with the aircraft, comprising:
the primary structure comprising a pyramidal part, the pyramidal part comprising a single rib, the single rib forming a base of the pyramidal part, and straight, upright members converging towards an apex of the pyramidal part, a fastening interface with the aircraft being disposed at the apex of the pyramidal part.

2. The primary structure of a support pylon of an aircraft engine assembly according to claim 1, wherein the pyramidal part is open on at least two faces.

3. The primary structure of a support pylon of an aircraft engine assembly according to claim 1, wherein the pyramidal part has four upright members.

4. The primary structure of a support pylon of an aircraft engine assembly according to claim 1, wherein the upright members are tubular.

5. The primary structure of a support pylon of an aircraft engine assembly according to claim 4, wherein the tubular upright members have a circular, square, rectangular or triangular section.

6. The primary structure of a support pylon of an aircraft engine assembly according to claim 1, wherein the upright members are made of titanium or titanium alloy.

7. The primary structure of a support pylon of an aircraft engine assembly according to claim 1, wherein the upright members have a profile reinforced by a cell structure.

8. The primary structure of a support pylon of an aircraft engine assembly according to claim 7, wherein the upright members have a C-section profile, the cell structure being arranged inside the “C” formed by the profile.

9. The primary structure of a support pylon of an aircraft engine assembly according to claim 1, wherein two upright members include a fin forming a flat extension of the section of same, the fin being designed to fasten a shear web between the two upright members.

10. The primary structure of a support pylon of an aircraft engine assembly according to claim 9, wherein the shear web is made of a composite material or from titanium.

11. The primary structure of a support pylon of an aircraft engine assembly according to claim 1, wherein the fastening interface with the aircraft forms a hole for a bearing or roller bearing.

12. The primary structure of a support pylon of an aircraft engine assembly according to claim 1, wherein the fastening interface with the aircraft is a yoke to receive a shaft, the straight upright members of the pyramidal part converging on the shaft.

13. The primary structure of a support pylon of an aircraft engine assembly according to claim 1, comprising, at one end of each upright member opposite the apex of the pyramidal part, a connection part that is linked to the upright member and configured to determine an orientation of the upright member in relation to a rest of the primary structure, and that is configured to be rigidly linked to the rest of the primary structure.

14. The primary structure of a support pylon of an aircraft engine assembly according to claim 1, comprising, in addition to the pyramidal part, a boxed structure to which the base of the pyramidal part is linked.

15. A support pylon of an aircraft engine assembly including a primary structure according to claim 1.
